(19) United States
(12) Patent Application Publication
(10) Pub. No.: US 2015/0188747 A1
(43) Pub. Date: Jul. 2, 2015

(54) CLOUD-BASED DATA CENTER INFRASTRUCTURE MANAGEMENT SYSTEM AND METHOD

(71) Applicant: AVOCENT HUNTSVILLE CORP., Huntsville, AL (US)

(72) Inventor: Bharat A. Khuti, Huntsville, AL (US)

(21) Appl. No.: 14/417,467

(22) PCT Filed: Jul. 26, 2013
(86) PCT No.: PCT/US2013/052308

§ 371 Date: Jan. 26, 2015

Related U.S. Application Data
(60) Provisional application No. 61/676,374, filed on Jul. 27, 2012.

(51) Int. Cl. H04L 12/24; G05B 15/02

(52) U.S. Cl. CPC H04L 41/046; G05B 15/02

(57) ABSTRACT

The present disclosure relates to methods for forming a data center infrastructure management (DOM) system. In one implementation the method may involve using a first portion of the DCIM system, including at least one DCIM application, as a cloud-based system. A second portion of the DCIM system may be used at a remote facility, the second portion making use of a hardware component. The second portion of the DCIM system may be used to obtain information from at least one device at the remote facility. A wide area network may be used to communicate the obtained information from the second portion to the first portion.

### CROSS-REFERENCE TO RELATED APPLICATIONS

This application is a PCT International Application that claims priority from U.S. Provisional Application Serial No. 61/676,374, filed on Jul. 27, 2012. The entire disclosure of the above-referenced provisional patent application is incorporated herein by reference.

### TECHNICAL FIELD

The present application is directed to data center infrastructure management (DCIM) systems and methods, and more particularly to a DCIM system having one or more of its hardware and or software components based in the cloud and available as a “service” to user.

### BACKGROUND

This section provides background information related to the present disclosure which is not necessarily prior art.

Cloud computing is presently growing rapidly around the world. By “cloud” computing, it is meant making a computing service available remotely as a service rather, over a wide area network, for example over the Internet. Thus, with cloud computing, a user will remotely access the computing and/or software applications that he/she requires to use, via a WAN or the Internet, rather than making use of computer with the required software running thereon at his/her location.

Previously developed data center infrastructure management (DCIM) systems, however, have typically relied on the user having the needed computing and software resources available at the user's site. Typically the user would be required to purchase, or at least lease, the required DCIM equipment. Obviously, this can represent a significant expense. Furthermore, if the user anticipates significant growth, then user may be in a position of having to purchase more DCIM assets (i.e., servers, memory, processors, monitoring software applications, etc.) than what may be needed initially, with the understanding that the excess DCIM capability will eventually be taken up as the data center expands.

Accordingly, it would be highly advantageous if one or more DCIM hardware and software products could be offered in the cloud to provide physical hardware and software products required by the user in managing and/or monitoring the user's data center products. In this manner the user could purchase or lease only those computing/monitoring services that are needed, and could easily purchase additional computing/monitoring services as the user's data center expands in size.

### SUMMARY

In one aspect the present disclosure relates to a method for forming a data center infrastructure management management (DCIM) system. The method may involve using a first portion of the DCIM system, including at least one DCIM application, as a cloud-based system. A second portion of the DCIM system may be used at a remote facility, the second portion making use of a hardware component. The second portion of the DCIM system may be used to obtain information from at least one device at the remote facility. A wide area network may be used to communicate the obtained information from the second portion to the first portion.

In another aspect the present disclosure relates to a method for forming a data center infrastructure management management (DCIM) system. The method may comprise using a first portion of the DCIM system as a cloud-based system. A second portion of the DCIM system may be used at a remote facility, the second portion including a hardware component forming at least one of a universal management gateway (UMG) for receiving information in serial form from at least one external device; a server for receiving information in the form of internet protocol (IP)_packets; and a facilities appliance for receiving information in one of serial form or IP packet form. The hardware component of the second portion of the DCIM system may be used to obtain the information from at least one device at the remote facility. A wide area network may be used to communicate the obtained information from the second portion to the first portion.

In still another aspect the present disclosure relates a method for forming a data center infrastructure management (DCIM) system. The method may comprise using multiple instances of a first portion of the DCIM system as a cloud-based system. A second portion of the DCIM system may be used at a remote facility, the second portion including a hardware component. The second portion of the DCIM system may be used to obtain information from at least one device at the remote facility. A wide area network may be used to communicate the obtained information from the second portion to the first portion.

### BRIEF DESCRIPTION OF DRAWINGS

The drawings described herein are for illustrative purposes only of selected embodiments and not all possible implementations, and are not intended to limit the scope of the present disclosure.

FIG. 1 shows a “hybrid” DCIM system in accordance with one embodiment of the present disclosure in which a portion of the DCIM system is made available in the cloud, for use as a service, by a user at a remote facility, and where the remote facility includes a component of the DCIM system, in this example a universal management gateway (UMG) device, running an MSS engine thereon;

FIG. 2 shows another embodiment of a hybrid DCIM system in which a portion of the DCIM system is made available as a service in the cloud, and an MSS engine of the DCIM system is located on a server at the user's remote facility;

FIG. 3 shows another embodiment of a DCIM system in which the DCIM system is made available in the cloud, and further where a virtual MSS engine is established on a virtual host accessible in the cloud;

FIG. 4 shows another embodiment of a DCIM system in which a virtual MSS engine is running on a virtual host, where the virtual host and its related DCIM system is in the cloud, and further where the remote facility makes use of a facilities appliance to communicate with both serial and IP devices;

FIG. 5 shows another embodiment of a hybrid DCIM system in which the facilities appliance of FIG. 4 is used with a server at the remote facility, and where the server is running an MSS engine, and where the remaining components of the DCIM system are in the cloud;

FIG. 6 shows another hybrid implementation of a DCIM system where the DCIM system is employed in a single instance in the cloud, to serve a single tenant;

FIG. 7 shows another hybrid implementation of a DCIM system where multi-instances of the DCIM system are created to handle separate UMGs; and

FIG. 8 shows a graph that illustrates how customization and infrastructure needs change depending on whether the DCIM system is configured for single instance or multi-instance use, as well as when the DCIM system is handling single tenant or multi-tenant usage.

### DETAILED DESCRIPTION

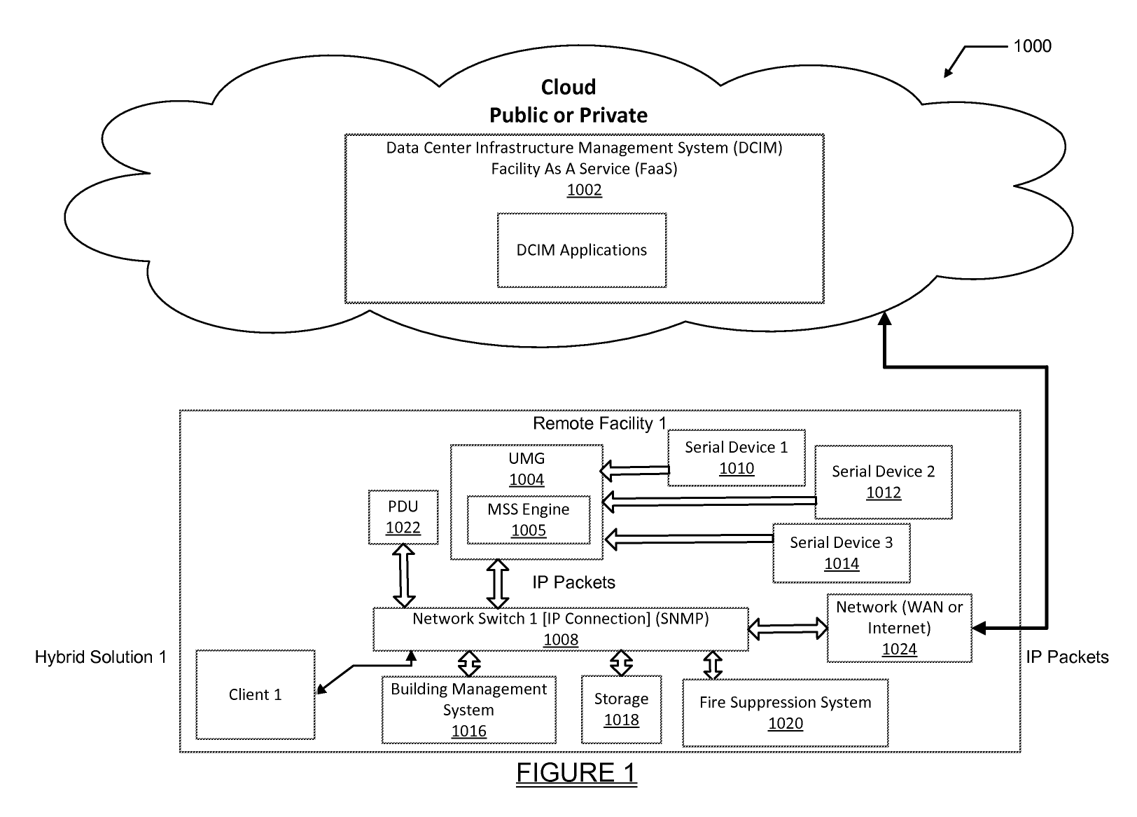

Referring to FIG. 56, an embodiment of a data center infrastructure management (“DCIM”) system 1000 is shown which makes use of a portion 1002 of the DCIM system 1000 made available in the cloud. The embodiment illustrated in FIG. 1 may also be viewed as a “hybrid solution”, where the portion 1002 of the DCIM system 1000 is employed in the cloud, and a portion (i.e., a Universal Management Gateway 1004) is employed at a remote physical facility. A Client is indicated at the remote facility (labeled “Remote Facility 1”). The Client can be considered as being a user that is part of a Tenant. A Tenant may be virtually any type of entity, such as an independent company, or may be a division of a company having a plurality of divisions, or a Tenant may simply be one or more individual clients (i.e., users). The Client may make use of one or more of any form of computing device(s), for example one or more desktop computers, laptop computers, terminals, tablets or even smartphones, or combinations thereof. And while the Client is shown in FIGS. 1-5 located within each of the Remote Facilities, it will be appreciated that the Client could just as readily be accessing the Remote Facility from some other remote location via a wide area connection.

Referring further to FIG. 1, the DCIM system 1002 may include the Universal Management Gateway (UMG) 1004, which may be a remote access appliance such as a KVM (keyboard, video, mouse) remote access appliance. The UMG 1004 may have a manageability subsystem (“MSS”) Engine 1005 (i.e., software module) for collecting data from various components being monitored. The operation of the MSS Engine 1005 is also described in U.S. provisional patent application Ser. No. 61/676,374, filed on Jul. 27, 2012, which has been incorporated by reference into the present disclosure. At Remote Facility 1 the UMG 1004 enables data analysis and aggregation of data collected from various components at Remote Facility 1. The UMG 1004 provides other highly useful capabilities such as pushing data up to other various components of the DCIM 1002 system, such as an MSS services subsystem (not shown but described in U.S. provisional patent application Ser. No. 61/676,374 referenced above) which may be located in the cloud. The MSS Engine 1005 may perform data point aggregation, analysis and may also generate event notifications when predetermined conditions have been met (e.g., temperature of a room has been exceeded for a predetermined time threshold). The MSS engine 1005 may then transmit aggregated data point information back to the DCIM system 1002 using a network 1024 connection (i.e., WAN or Internet).

The DCIM system 1002 may include one or more DCIM applications 1006 for managing or working with various components at Remote Facility 1. At Remote Facility 1 the UMG 1004 may be coupled to both a network switch 1008 as well as one or more serial devices 1010, 1012 and 1014, and thus may be able to receive and transmit IP packets to and from the network switch 1008, as well as to communicate serial data to the serial devices 1010-1014 or to receive serial data from the serial devices 1010-1014. The serial devices 1010-1014 may be any types of serial devices, for example temperature sensing devices, humidity sensing devices, voltage monitoring devices, etc., or any type of computing device or peripheral that communicates via a serial protocol. The network switch 1008 may also be in communication with a wide variety of other devices such as, without limitation, a building management system 1016, a data storage device 1018, a fire suppression system 1020, a Power Distribution Unit (PDU) 1022 and the network 1024 (wide area network or the Internet). Virtually any type of component that may communicate with the network switch 1008 could potentially be included, and the components 1016-1022 are only meant as non-limiting examples of the various types of devices that could be in communication with the network switch 1008. The embodiment shown in FIG. 1 may potentially provide a significant cost savings to the operator of Remote Facility 1 by eliminating the need to provide a full DCIM system at Remote Facility 1. Instead, just the UMG 1004 and the MSS engine 1005 are provided at Remote Facility 1, and the DCIM system 1002 may provide only those DCIM services that are required and requested by the operator of Remote Facility 1.

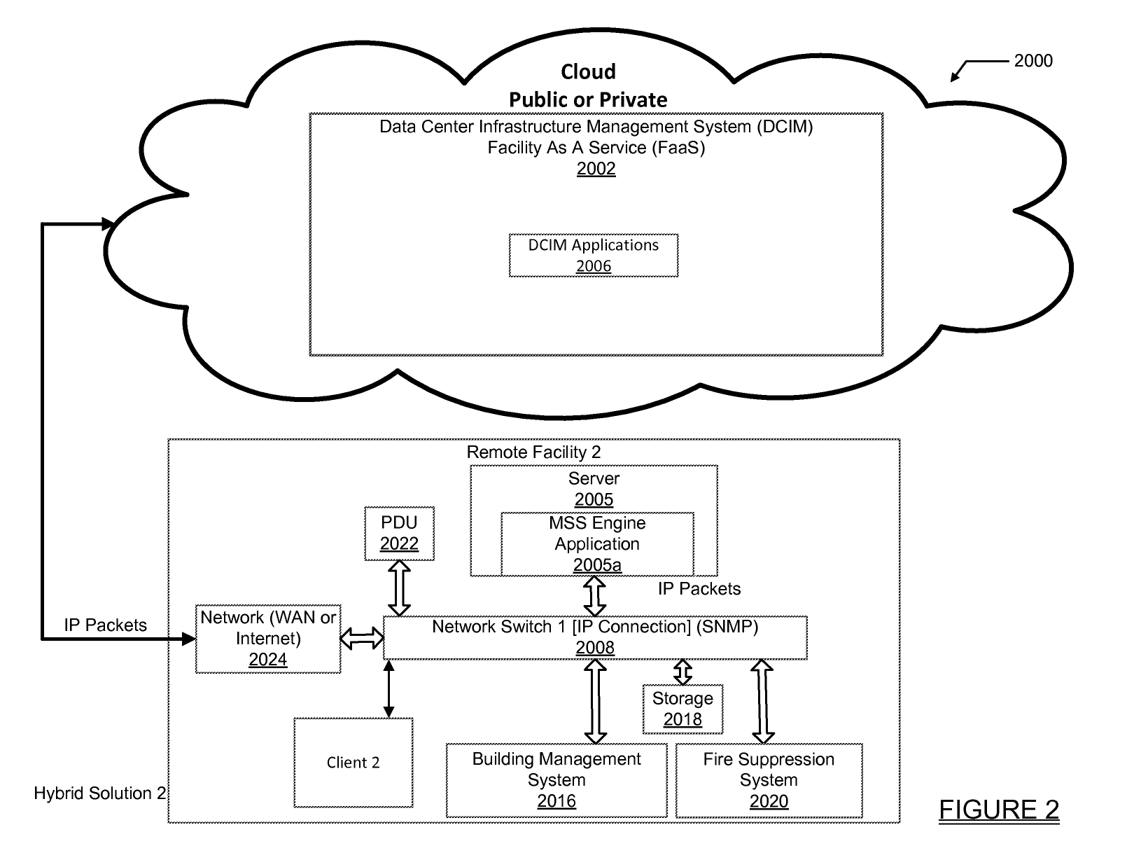

Referring to FIG. 2, another hybrid system 2000 is shown in which a cloud based DCIM system 2002 forms a “facility as a service”. The system 2000 is shown in communication with a Remote Facility 2 which includes several components identical to those described in connection with Remote Facility 1. Those identical components are denoted by the same reference numbers used with the description of Remote Facility 1 but increased by 1000. The DCIM system 2002 may include one or more DCIM applications 2006. However, Remote Facility 2 includes a server 2005 in place of the UMG 1004 of FIG. 1. The server 2005 may include an MSS engine 2005a forming a software component for collecting and analyzing data, in this example IP packets, received from a network switch 2008. The network switch 2008 may be in communication with a wide area network (WAN) 2024 that enables the network switch 2008 to access the cloud-based DCIM system 2002. The network switch 2008 may also be in communication with a building management system 2016, a data storage device 2018, a fire suppression system 2020 and a PDU 2022. Client 2 may access the cloud-based DCIM 2002 via the network switch 2008 and network 2024. System 2000 of FIG. 2 thus also forms a “hybrid” solution because a portion of the DCIM system 2002 (i.e., MSS engine 2005a) is located at Remote Facility 2, while the remainder of the DCIM system 2002 is cloud-based and available as a service to Client 2.

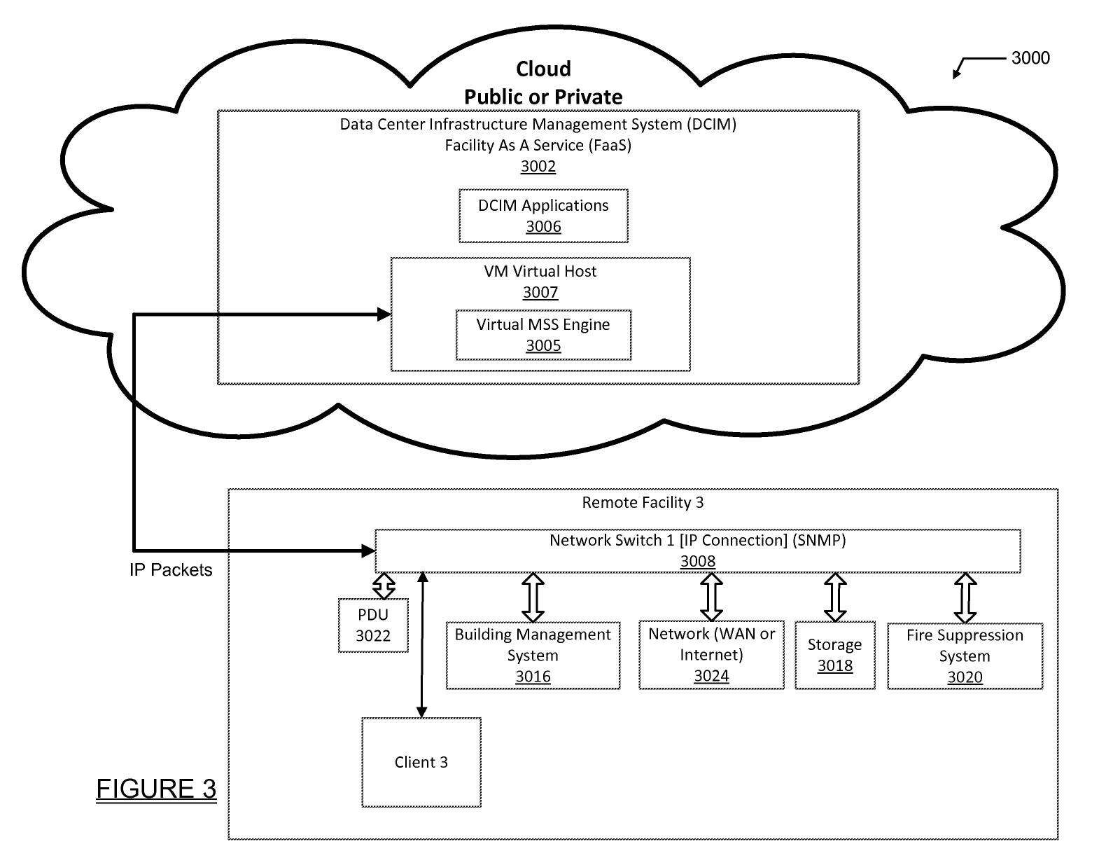

Referring now to FIG. 3, another system 3000 is shown where an entire DCIM system 3002 is cloud-based and used as a “service” by Client 3, and further where a portion of the DCIM system, an MSS engine 3005, is provided as a “virtual” component on a virtual host computer 3007. Again, in this embodiment components in common with those explained in FIG. 1 will be denoted with reference numbers increased by 2000. The DCIM system 3002 may include one or more DCIM applications 3006 that may be accessed “as a service” by Client 3 from Remote Facility 3. The Remote Facility 3 may have a network switch 3008 in communication with a building management system 3016, a data storage device 3018 such as a database, a fire suppression system 3020 and a PDU 3022. Data collected from components 3016, 3018, 3020 and 3022 may be communicated via network 3024 to the cloud-based DCIM 3002. The virtual MSS engine 3005 may perform monitoring and analysis operations on the collected data , and one or more of the DCIM applications 3006 may be used to report various events, alarms or conditions concerning the operation of the components at Remote Facility 3 back to Client 3. This embodiment may also represent a significant cost savings for the operation of Remote Facility 3 because only those data center monitoring/analysis operations required by the operator of Remote Facility 3 may be used as a cloud-based service. Plus, the MSS engine is “virtualized”, and thus provided as a cloud-based service to the operator of Remote Facility 3, which eliminates the need to provide it as a hardware or software item at Remote Facility 3. Thus, the operator of Remote Facility 3 in this example would not need to purchase any hardware components relating to the DCIM system 3002; instead the DCIM hardware and software is fully provided as a service in the cloud.

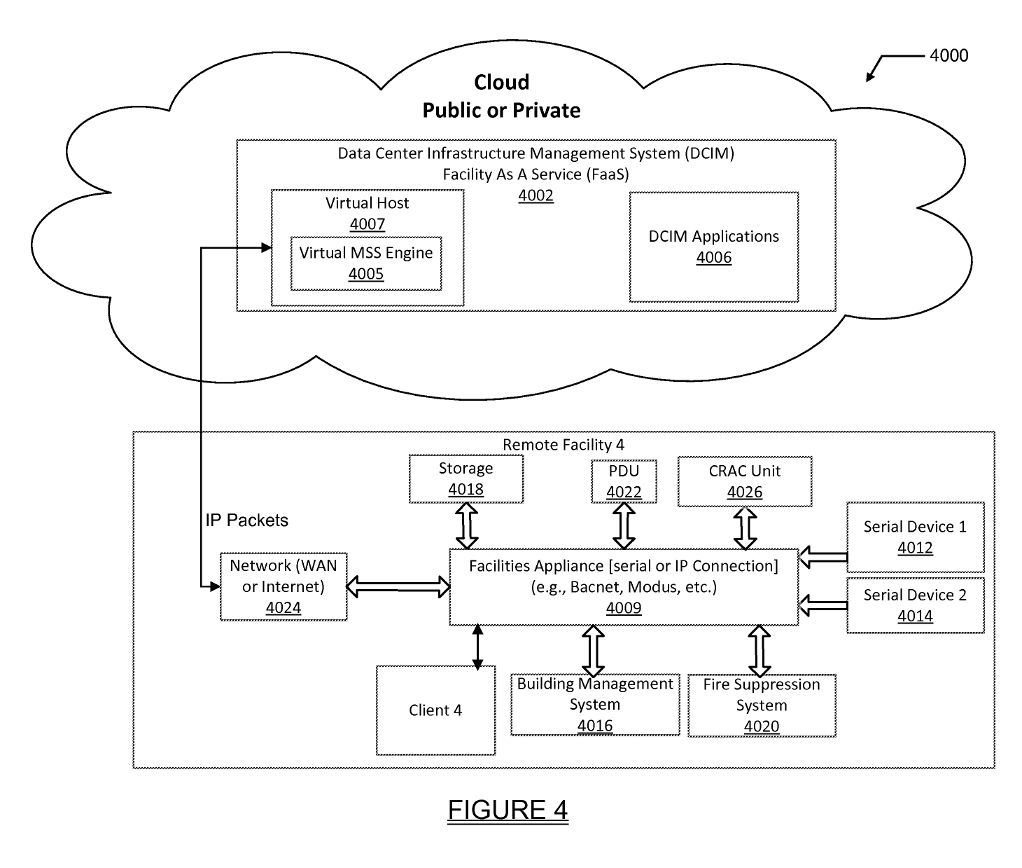

Turning now to FIG. 4, still another example of a system 4000 is illustrated in which a DCIM system 4002 is provided in the cloud, but where a Remote Facility 4 includes a facilities appliance 4009 in place of a network switch. The facilities appliance 4009 may provide communication capabilities with both serial devices, such as serial devices 4012 and 4014, as well as those devices that communicate by sending and/or receiving IP packets. Such components communicating via IP packets may be a building management system 4016, a data storage device 4018, a fire suppression system 4020, a PDU 4022, and a CRAC (computer controlled air conditioning) unit 4026. The facilities appliance 4009 may communicate with the cloud-based DCIM 4002 via a network 4024. The cloud-based DCIM 4002 may include a virtual host computer 4007 running a virtual MSS engine 4005. The cloud-based DCIM applications 4006 may be accessed by Client 4 via the network 4024 as needed.

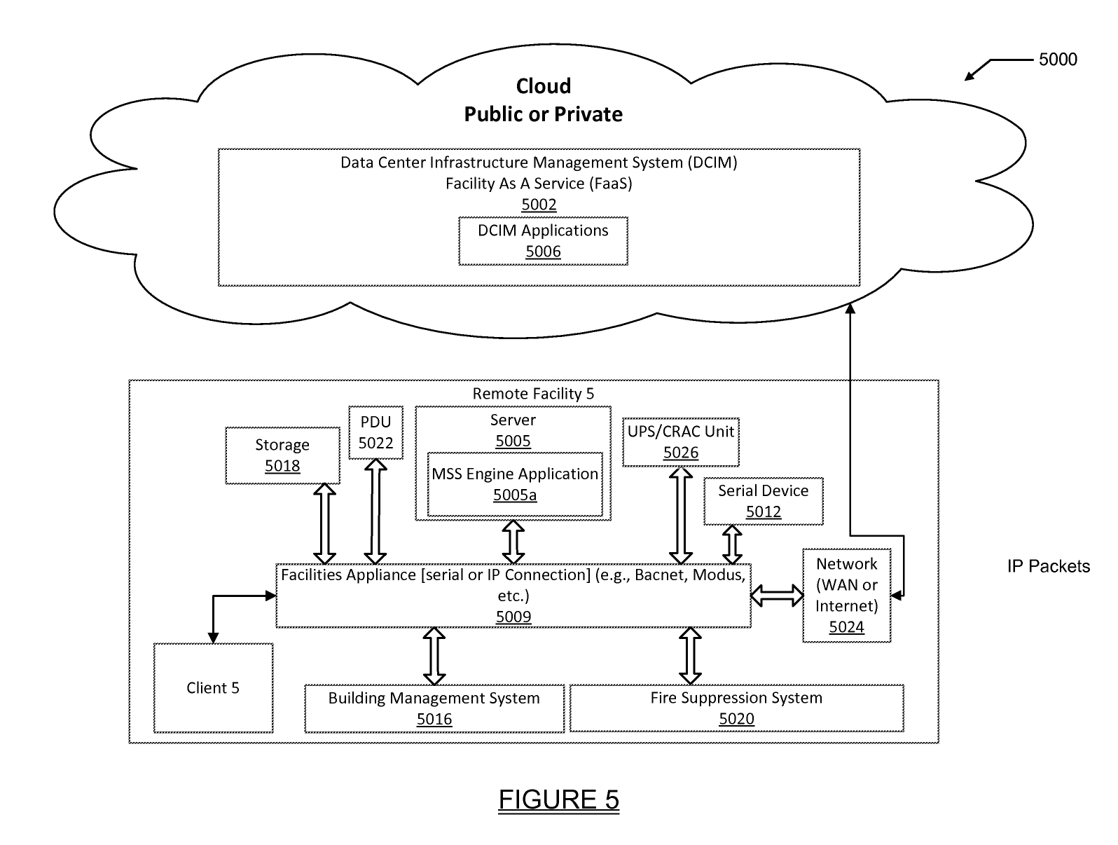

FIG. 5 shows still another example of a system 5000 in which a cloud-based DCIM system 5002 functions as a service for Client 5 at a Remote Facility 5. In this example a server 5005 having a software MSS engine 5005a communicates with a facilities appliance 5009. The facilities appliance 5009 can communicate with both serial protocol and IP protocol devices. The facilities appliance 5009 communicates with the cloud-based DCIM system 5002 via a network 5024. In this example a serial device 5012, a building management system 5016, a fire suppression system 5020, a data storage device 5018, a PDU 5022 and a CRAC unit 5026 are all in communication with the facilities appliance 5009. As a variation of this implementation, a virtual host computer could instead be implemented at Remote Facility 5 with an instance of a virtual MSS engine running thereon.

In summary, providing all or a major portion of a DCIM system in the cloud enables a substantial portion, or possibly even all, of the DCIM hardware and software components to be offered as a “service” to customers. This better enables a user to use only the data center infrastructure management services that are needed for the user's data center at a given time, but still allows the user to easily accommodate new data center equipment as same is added to the user's data center by increasing the data center infrastructure management capabilities offered in the cloud-based DCIM system. Thus, for example, if the Remote Facility 1 of FIG. 1 was to grow to include double the data center equipment shown in FIG. 1, then the user could easily accommodate such growth by using a plurality of MSS Engines 1005 running on one or more UMGs 1004. Likewise, offering all or a portion of the DCIM system as a service allows users to make use of only those cloud-based data center management services that are needed at the present time, while still providing the opportunity to scale up or down the used services as their data center management needs change.

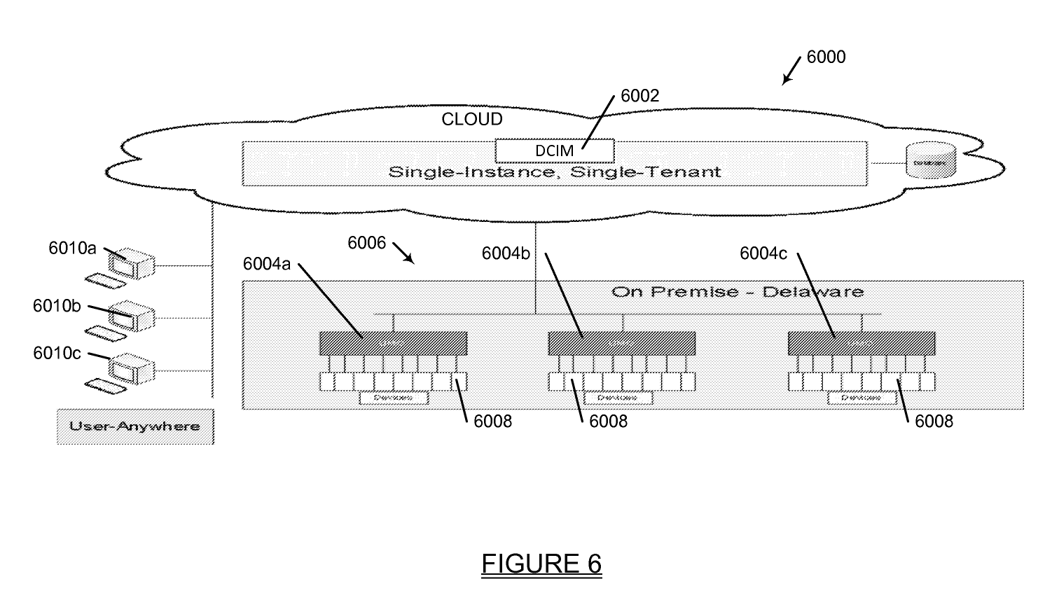

Referring now to FIGS. 6-8, various embodiments of a hybrid s DCIM system, with at least a portion of the DCIM system being located in the cloud, are illustrated. Referring specifically to FIG. 6, a DCIM system 6000 is shown where a single instance, single tenant DCIM 6002 is provided. This embodiment makes use of a plurality of UMGs 6004a, 6004b and 6004c at a remote location 6006. Each UMG 6004a, 6004b and 6004c may be to communicating with a plurality of independent devices 6008. A plurality of users 6010a, 6010b and 6010c may be accessing the DCIM 6002 over a wide area network 6010. Each of the user's 6010a, 6010b and 6010c will essentially be using the DCIM 6002 “as a service”, and may be using the DCIM 6002 to obtain information from one or more of the UMGs 6004a-6004c.

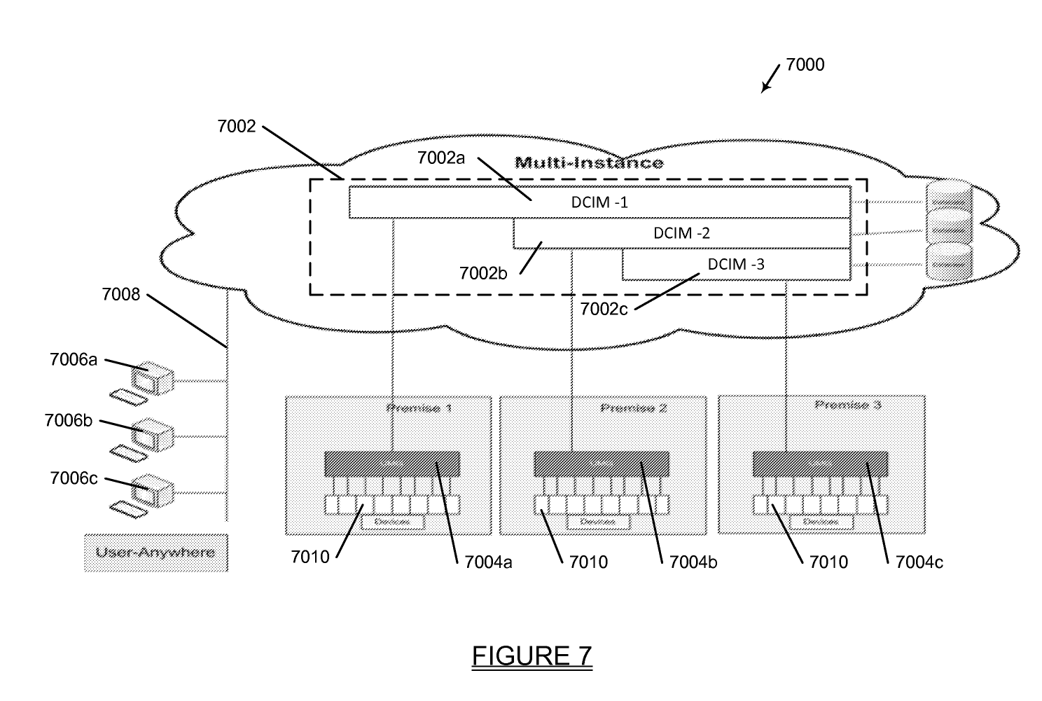

FIG. 7 illustrates a system 7000 in which a cloud-based DCIM system 7002 has a plurality of instances 7002a, 7002b and 7002c created. The DCIM instances 7002a, 7002b and 7002c in this example independently handle communications with a corresponding plurality of UMGs 7004a, 7004b and 7004c, respectively. Users 7006a, 7006b and 7006c each communicate with the DCIM system 7002 via a wide area network 7008. The UMGs 7004a, 7004b and 7004c are each handling communications with a plurality of devices 7010. The instances 7002a, 7002b and 7002c of the DCIM system 7002 essentially operate as separate DCIM “software systems”. Each of the users 7006a, 7006b and 7006c may be using separate ones of the DCIM instances 7002a, 7002b and 7002c to communicate or obtain information from any one or more of the UMGs 7004.

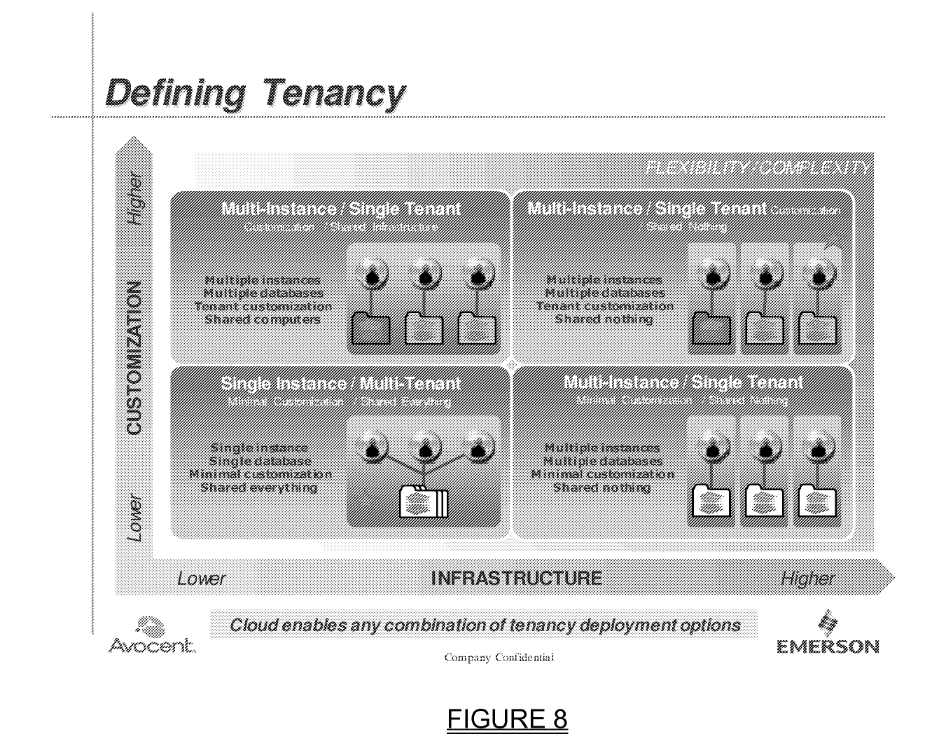

FIG. 8 graphically illustrates how a degree of customization and infrastructure requirements are affected by configuring the DCIM system 6002 or 7002 for single instance or multi-instance usage. From FIG. 8 it can also be seen how resources are shared depending on whether a single tenant or a multi-tenant configuration is in use.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A method for forming a data center infrastructure management management (DCIM) system, comprising:
using a first portion of the DCIM system, including at least one DCIM application, as a cloud-based system;
using a second portion of the DCIM system at a remote facility, the second portion including a hardware component;
using the second portion of the DCIM system to obtain information from at least one device at the remote facility; and
using a wide area network to communicate the obtained information from the second portion to the first portion.

2. The method of claim 1, wherein using the second portion of the DCIM system, including the hardware component, comprises using a universal management gateway (UMG) with the second portion, the UMG being configured to receive serial communications with the at least one device at the remote facility.

3. The method of claim 1, further comprising using a network switch at the remote facility to interface the hardware component with the wide area network.

4. The method of claim 3, further comprising interfacing at least one of the following systems to the network switch:
a building management system;
a storage subsystem;
a fire suppression system; and
a power distribution unit (PDU).

5. The method of claim 1, wherein using the second portion of the DCIM system, including the hardware component, comprises:
using the second portion with a server running a manageability subsystem (MSS) engine application and configured to communicate internet protocol (IP) packets of information from the server to a network switch at the remote facility; and
using the network switch to interface the server to the wide area network.

6. The method of claim 5, further comprising interfacing at least one of the following systems to the network switch:
a building management system;
a fire suppression system; and
a power distribution unit (PDU).

7. The method of claim 1, wherein using a first portion of the DCIM system, including at least one DCIM application, as a cloud-based system, comprises using the first portion with a virtual host computer system running a virtual manageability subsystem (MSS) engine.

8. The method of claim 7, wherein using the second portion of the DCIM system at a remote facility, the second portion including a hardware component, comprises using a facilities appliance as the hardware component at the remote facility and using the facilities appliance to communicate with both serial and internet protocol (IP) devices at the remote facility.

9. The method of claim 8, further comprising using the facilities appliance to communicate with at least one of:
a storage subsystem;
a power distribution unit (PDU);
a computer room air conditioning (CRAC) unit;
a serial device;
a building management system;
a fire suppression system; and
a client hardware device for generating communications from a client.

10. The method of claim 1, wherein using the second portion of the DCIM system at a remote facility, the second portion including a hardware component, comprises using the following components as the hardware component:
a server running a manageability subsystem (MSS) engine to collect data from other devices at the remote facility; and
a facilities appliance for communicating with the server and interfacing to the wide area network.

11. The method of claim 1, wherein using the first portion of the DCIM, including at least one DCIM application, as a cloud-based system, comprises using multi-instances of the DCIM.

12. A method for forming a data center infrastructure management (DCIM) system, comprising:
using a first portion of the DCIM system as a cloud-based system;
using a second portion of the DCIM system at a remote facility, the second portion including a hardware component forming at least one of:
a universal management gateway (UMG) for receiving information in serial form from at least one external device;
a server for receiving information in the form of internet protocol (IP)_packets;
a facilities appliance for receiving information in one of serial form or IP packet form;
using the hardware component of the second portion of the DCIM system to obtain the information from at least one device at the remote facility; and
using a wide area network to communicate the obtained information from the second portion to the first portion.

13. The method of claim 12, further comprising running a software DCIM application in the first portion of the DCIM system.

14. The method of claim 12, further comprising using a network switch to interface the hardware component to the wide area network.

15. The method of claim 12, further comprising using a virtual host computing device with the first portion of the DCIM system based in the cloud.

16. The method of claim 15, further comprising running a virtual MSS engine in the virtual host computing device, the virtual MSS engine comprising a software engine for collecting the information from the second portion of the DCIM system received via the wide area network.

17. The method of claim 12, further comprising using multiple instances of the first portion of the DCIM system in the cloud.

18. A method for forming a data center infrastructure management (DCIM) system, comprising:
using multiple instances of a first portion of the DCIM system as a cloud-based system;
using a second portion of the DCIM system at a remote facility, the second portion including a hardware component;
using the second portion of the DCIM system to obtain information from at least one device at the remote facility; and
using a wide area network to communicate the obtained information from the second portion to the first portion.

19. The method of claim 18, further comprising using a DCIM application as a component of the first portion of the DCIM system.

20. The method of claim 18, further comprising using at least one of a universal management gateway, a server or a facilities appliance as the hardware component of the second portion of the DCIM system.
